(19) United States
(12) Patent Application Publication
(10) Pub. No.: US 2024/0028935 A1
(43) Pub. Date: Jan. 25, 2024

(54) CONTEXT-AWARE PREDICTION AND RECOMMENDATION

(71) Applicant: Accenture Global Solutions Limited, Dublin (IE)

(72) Inventors: Vinay Avinash Dorle, Bangalore (IN); Santosh Kumar Soni, Bengaluru (IN); Vikash Choudhary, Bangalore (IN); Shivam Mathur, Bengaluru (IN); Paritosh Pramanik, Bangalore (IN)

(21) Appl. No.: 17/870,004

(22) Filed: Jul. 21, 2022

(51) Int. Cl. G06N 7/00; G06N 20/00; G06N 5/02

(52) U.S. Cl. CPC G06N 7/005; G06N 20/00; G06N 5/022

(57) ABSTRACT

Methods, computer systems, and apparatus, including computer programs encoded on computer storage media, for training a machine-learning model configured to generate a prediction and recommendation output from input data. The system obtains training data including a plurality of training examples, obtains context data, identifies one or more feature variables from the context data, constructs the machine-learning model based at least on the identified feature variables, generates feature variable training data by processing the training data based on the identified feature variables, and performs training and periodic update (if required) of the machine-learning model to generate model parameter data for the machine-learning model based at least on the generated feature variable training data.

### FIELD

This specification relates to machine-learning models for making predictions and recommendations, such as recommending approaches for providing services.

### BACKGROUND

A machine-learning model can be used to make recommendations by processing input data characterizing a particular scenario to generate an output that indicates a recommendation for the particular scenario. The machine-learning model has a plurality of model parameters. The values of the model parameters can be determined using a training process based on training data.

In one example, the machine-learning model can be a regression model. The regression model can characterize a functional relationship between an output variable and one or more independent input variables or features. The functional relationship of the regression model is parameterized by the model parameters, e.g., coefficients, of the regression model. The regression model can be trained using an optimization process, such as the gradient descent process, using the training data to minimize an estimated loss function.

In another example, a machine-learning model can be a neural network. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with the current values of a respective set of parameters. The neural network can be trained using any backpropagation-based machine learning techniques, e.g., using the Adam or AdaGrad optimizers.

### SUMMARY

This specification describes computer-implemented systems and methods for making a prediction and a recommendation.

In one example, the recommendation can be an “as a service” (Xaas) recommendation for a particular scenario. For example, the recommendation system can generate a prediction and recommendation output that indicates whether to offer a product to a client as a service or as a one-time sale item. In another example, the system can generate a prediction and recommendation output that indicates whether to offer a service to a client as an on-demand service or a subscription-based service.

More broadly, the recommendation can be a recommendation for a particular approach for allocating services or resources by a provider system. For example, the recommendation system can be used to provide a recommendation on how to allocate computing resources to different applications, e.g., whether to dedicate a portion of the computing resources exclusively to a particular application, or to allocate multiple portions of the computing resources to multiple applications on a time-sharing or on-demand basis. In another example, the system can be used to provide a recommendation on how to allocate manufacturing facilities to manufacturing different products, e.g., whether to dedicate a particular product line to manufacturing a particular product, or to share multiple production lines for manufacturing multiple products. In some scenarios, the prediction and recommendation output generated by the system can be used to automatically control the provider system to perform an action, e.g., to allocate the computational resources or manufacturing capabilities according to the prediction and recommendation output.

In a first aspect, this specification provides a training method for training a machine-learning model a machine-learning model configured to generate a prediction and recommendation output from input data. The training method can be performed by a system comprising one or more computers. The system obtains training data including a plurality of training examples, obtains context data characterizing a context of a scenario, identifies one or more feature variables having sufficient predictive power from the context data, constructs the machine-learning model based at least on the identified feature variables, generates feature variable training data by processing the training data based on the identified feature variables, and performs training of the machine-learning model to generate model parameter data for the machine-learning model based at least on the generated feature variable training data.

In some implementations of the training method, the context data includes text data. To identify the one or more feature variables having sufficient predictive power from the context data, the system performs topic modeling of the text data to extract a list of topics, identifies a list of candidate feature variables based on the list of topics, and identifies the one or more feature variables based on the list of candidate feature variables. For example, the system can determine whether the list of candidate feature variables are independent variables, and in response to determining that inter-dependencies exist in the list of candidate feature variables, removes one or more of the candidate feature variables from the list to remove multi-collinearity from the list of candidate feature variables. To determine whether the list of candidate feature variables are independent variables, the system can determine one or more statistical parameters of the candidate feature variables, such as a variance inflation factor (VIF), a Pearson correlation coefficient, a Spearman's rank correlation coefficient, or a Kendall rank correlation coefficient, compare the one or more determined statistical parameters with one or more threshold values, and determine whether the list of candidate feature variables are independent variables based on the comparison result.

In some implementations of the training method, the input data includes one or more parameters characterizing a client system, and the prediction and recommendation output indicates whether to recommend a particular approach for performing a service to the client system.

In some implementations of the training method, the input data includes one or more parameters characterizing a task, and the prediction and recommendation output indicates whether to recommend a particular approach for allocating resources for performing the task.

In some implementations of the training method, to perform training of the machine-learning model, the system determines one or more parameters indicating a predictive value of the feature variable training data, and determines, based on the one or more parameters, whether the training data satisfies a sufficiency condition. The one or more parameters can include a Cohen's effect size, a coefficient of determination, or a mean-squire error computed by fitting the feature variable training data to a predictive model. The system can compare the Cohen's effect size, the coefficient of determination, or the mean-squire error to a threshold value, and determine whether the training data satisfy the sufficiency condition based on the comparison result. In response to the training data satisfying the sufficiency condition, the system can perform training of the machine-learning model using a frequentist training technique based on the feature variable training data. The system can further obtain domain knowledge data that characterizes prior probabilities of the feature variables. In response to the training data not satisfying the sufficiency condition, the system can perform training of the machine-learning model using a Bayesian training technique based at least on the prior probabilities of the feature variables.

In some implementations of the training method, the system further obtains test data, performs a statistical hypothesis test on the feature variable training data and feature variable test data generated for the test data, determines, based at least on result of the statistical hypothesis test, whether to perform an updated training of the machine-learning model, and in response to determining to perform the updated training, performs training of the machine-learning model on an updated set of training examples. The statistical hypothesis test can include one or more of: a T-test, a Z-test, a chi-square test, an ANOVA test, a binomial test, or a one sample median test. To determine whether to perform an updated training of the machine-learning model, the system can determine a value of an error metric of the machine-learning model based on the test data, and determines, based on the result of the statistical hypothesis test and the error metric, whether to perform an updated training of the machine-learning model.

In some implementations of the training method, the system further performs a clustering analysis of the training data, segments the training data into a plurality of training subsets, and performs training of the machine-learning model using each of the training subsets. For example, the clustering analysis can be performed using affinity propagation.

In some implementations of the training method, to generate the feature variable training data, the system processes the training data based on the identified feature variables using Monte Carlo Markov Chain (MCMC) or No-U turn sampling to generate the feature variable training data.

In a second aspect, this specification provides a method for providing service recommendations. The method can be implemented by a system including one or more computers. The system obtains input data that includes at least one or more first parameters characterizing a service-providing system, processes the input data using a machine learning model to generate a prediction and recommendation output that indicates whether to recommend a particular approach for performing a service by the service-providing system, wherein the machine-learning model has been trained by a training method described in the first aspect. The system further performs an action based on the prediction and recommendation output.

In a third aspect, this specification provides a system comprising one or more computers and one or more storage devices storing instructions that when executed by the one or more computers cause the one or more computers to perform the methods described in the first aspect and the second aspect.

In a fourth aspect, this specification provides one or more non-transitory computer storage media encoded with instructions that, when executed by one or more computers, cause the one or more computers to perform the methods described in the first aspect and the second aspect.

The subject matter described in this specification can be implemented in particular embodiments so as to realize one or more of the following advantages.

Conventional machine-learning techniques for making a service or resource allocation related recommendation involve training a machine-learning model tailored to the specific application using training data. One limitation is that such a machine-learning model can only be applied to a pre-defined type of scenario, and for a different type of scenario, a new machine-learning model often needs to be hand-crafted and tuned through trial and error. For example, indicator or predictor variables used for the machine-learning model are often selected in an ad hoc manner without checking the multi-collinearity and variable dependency. This causes in-efficiency in model construction as well as a sub-optimal performance of the machine-learning model. The techniques provided by this specification use a context-aware approach to construct the machine-learning model, e.g., by automatically identifying the feature variables based on context data. By performing model construction using the context data, the provided system can be used to address a broad range of applications. In some implementations, the provided system further performs inter-dependency analysis on candidate feature variables and removes the dependent feature variables (also known as multi-collinearity problem in linear regression). This approach improves the efficiency of the model construction and can potentially improve the performance of the constructed machine-learning model, i.e., by producing machine-learning models that generate higher quality recommendations for a broad range of scenarios, requires fewer computational resources to use and/or train, or both.

Another limitation of the conventional machine-learning models is that they often require a substantial amount of training data, e.g., historical data for the particular or related applications. When the available training data is not sufficient, the trained machine-learning model does not produce appropriate prediction and recommendation outputs. In some implementations of the techniques provided by this specification, the system combines the frequentist approach and the Bayesian approach for constructing and training the machine-learning model. For example, if sufficient training data is available, the system can adopt a frequentist machine-learning model and use a frequentist machine-learning technique to train the machine-learning model. On the other hand, if sufficient training data is not available, the system can adopt a Bayesian machine-learning model and use a Bayesian machine-learning technique to train the machine-learning model. As a result, the trained machine-learning model can produce high-quality prediction and recommendation outputs even if the available training data is not sufficient.

Another limitation of the conventional machine-learning models is that the performance of the trained machine-learning model can degrade over time when the characteristics and statistics of new input data evolve over time. In some implementations, the provided system can repeatedly perform an evaluation of the machine-learning model to monitor the model performance, and update the model parameters (e.g., through additional training) when the system determines it to be necessary. Thus, the system can keep track and maintain the performance of the machine-learning model even when the input data changes characteristics, e.g., statistical characteristics.

### BRIEF DESCRIPTION OF THE DRAWINGS

FIG. 1 shows an example system for making a recommendation.

FIG. 2 shows an example model construction and training system for constructing and training a recommendation machine-learning model.

FIG. 3 is a flow diagram illustrating an example process for constructing and training a machine-learning model for making a recommendation.

FIG. 4 is a flow diagram illustrating an example process for training a machine-learning model for making a recommendation.

FIG. 5 shows an example computer system.

Like reference numbers and designations in the various drawings indicate like elements.

### DETAILED DESCRIPTION

Machine-learning models are powerful tools for recognizing patterns in the input data for generating an output, such as a prediction and recommendation output for making a recommendation for a particular scenario. This specification provides a solution for constructing and training a recommendation machine-learning model for making the recommendation based on context data.

For example, the machine-learning model can be used for making a recommendation for a particular approach for providing services or resources by a provider system. In one example, the system can be used to provide a recommendation on how to allocate computing resources to different applications, e.g., whether to dedicate a portion of the computing resources to a particular application, or to share multiple portions of the computing resources with multiple applications, e.g., on a time-sharing or an on-demand basis. In another example, the system can be used to provide s recommendation on how to allocate manufacturing facilities to manufacturing different products, e.g., whether to dedicate a particular product line to manufacturing a particular product, or to share multiple production lines for manufacturing multiple products. In some scenarios, the prediction and recommendation output generated by the system can be used to automatically control the provider system to perform an action, e.g., to allocate the computational resources or manufacturing capabilities according to the prediction and recommendation output.

In a particular example, the system can generate an “as a service” (Xaas) recommendation for a particular scenario. For example, the system can process input data to generate a prediction and recommendation output that indicates whether to offer a product to a client as a service or as a one-time sale item. In another example, the system can generate a prediction and recommendation output that indicates whether to offer a service to a client as an on-demand service or a subscription-based service.

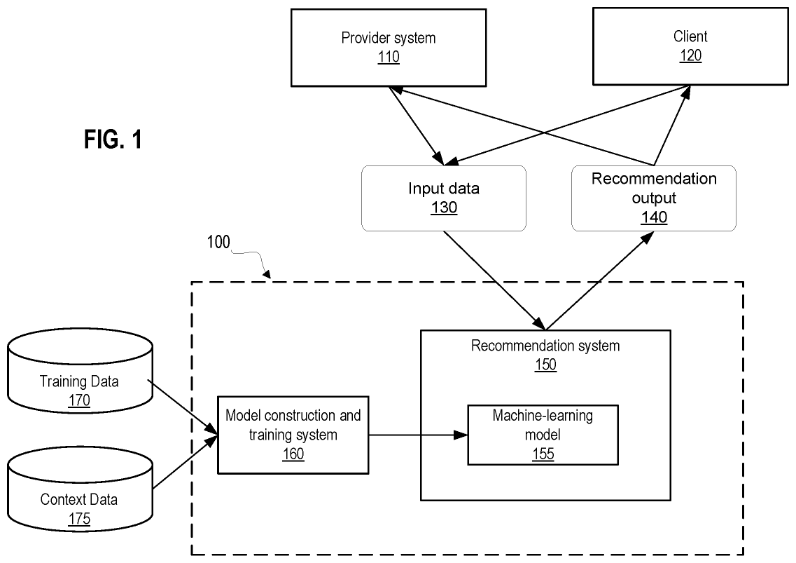

FIG. 1 illustrates an example system 100 for making a recommendation. The system 100 is an example of a system implemented as computer programs on one or more computers in one or more locations, in which the systems, components, and techniques described below can be implemented.

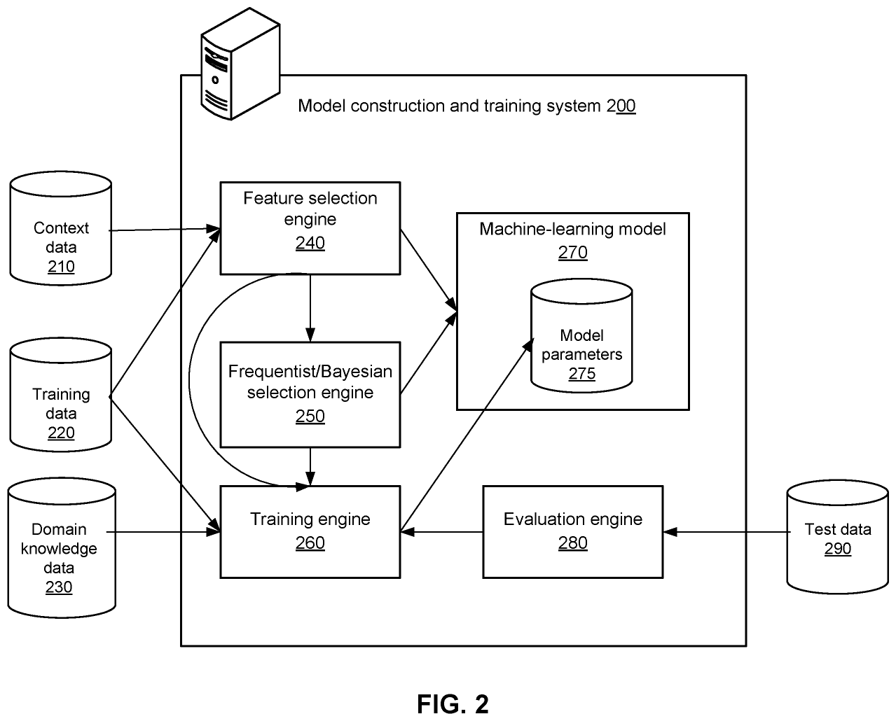

The system 100 includes a recommendation system 150 and a model construction and training system 160. The model construction and training system 160 uses training data 170 and context data 175 to construct and train a machine-learning model 155. Examples of the model construction and training system 160 will be described in detail with reference to FIG. 2.

The recommendation system 150 receives input data 130 and uses the trained machine-learning model 155 to generate a prediction and recommendation output 140. The input data can include one or more parameters (e.g., numerical metrics) characterizing a client 120. The input data can further include one or more parameters (e.g., numerical metrics) characterizing a provider system 110. The machine-learning model can be any appropriate model that performs a regression on the model input to generate a predictive output. For example, the machine-learning model can be a regression model, e.g., a linear regression model. In another example, the machine-learning model can include a neural network that includes a regression output layer.

In some implementations, the client 120 can be an entity requiring services or resources, such as a potential customer, from a provider system 110. The client 120 can potentially receive the services or resources on an “as a service” basis or as a one-time sale item. For example, for a printing service, the client can receive the service on the “as a service” basis by being charged for the amount of required printing service (e.g., the number of printed pages). Alternatively, the client can receive the printing service by purchasing a printer or by subscribing to a printing service with a fixed fee. The input data 130 can include data collected on the client, including, for example, data characterizing the sales order amount, consumption based billing, service cost trend, service request trend, customer satisfaction score (CSAT), revenue trend, future insight score, revenue trend, purchase frequency trend, and so on, of the client. The prediction and recommendation output 140 can indicate whether to recommend a particular approach for performing a service to the client. For example, the prediction and recommendation output 140 can include a predicted as-a-service propensity score that characterizes a willingness of the client to receive the service on the “as a service” basis. The prediction and recommendation output 140 can be used for further analysis. For example, the prediction and recommendation output 140 for multiple products can be used to perform a market basket analysis (MBA) to uncover associations between different services. The provider system can use the MBA result for recommending an associated product to the client. In another example, the prediction and recommendation output 140 for multiple clients can be used to perform a clustering analysis to provide insight into client acquisition or management.

In some other implementations, the client system 120 can be a task that requires resources. For example, the client 120 can be a software application or a computation task that requires computational resources from the provider system 110 (e.g., a computer server). In another example, the client 120 can be a manufacturing task for manufacturing a product, and requires manufacturing resources from the provider system 110 (e.g., one or more production lines). The input data 130 can include data characterizing the task, including, for example, timeline requirement, resource amount requirement, urgency, importance, coordination requirement on other tasks, and so on. The prediction and recommendation output 140 can indicate whether to recommend a particular approach for allocating resources for performing the task. For example, the prediction and recommendation output 140 can include a score that measures the benefit of allocating the resources to the task exclusively or sharing with other tasks. The provider system or the client can receive the prediction and recommendation output 140 to guide a future action.

FIG. 2 shows an example of a model construction and training system 200. The system 200 is an example of a system implemented as computer programs on one or more computers in one or more locations, in which the systems, components, and techniques described below can be implemented.

In general, the system 200 receives context data 210 and training data 220, and performs constructions and training of the machine-learning model 340 based on the received data. The training data 220 includes a plurality of training examples with each training example including a particular training input and an output label corresponding to the particular training input. The output label can be a ground-truth label of a regression based score, e.g., an as-a-service propensity score.

The system 200 includes a feature selection engine configured to identify one or more feature variables from the context data 210. The feature variables are independent variables that have predictive power, and are the input to the machine-learning model 270 for generating the prediction and recommendation output. In some implementations, the context data 210 includes text data that describes or characterizes the client or the provider system, or both. For example, the context data can include text relevant to the provider system or the client. The relevant text can be obtained from a variety of sources, such as advertising materials, blogs, annual reports, online forums, and so on. The feature selection engine 240 can perform natural language processing (NLP) and/or topic modeling to extract a list of topics and keywords from the text data, and identifies a list of candidate feature variables based on the list of topics or keywords.

The system 200 can perform a multi-collinearity check on the candidate feature variables to determine whether the list of candidate feature variables are independent variables, and removes any redundant candidate feature variables from the list in response to determining that inter-dependencies exist in the list of candidate feature variables. For example, the system 200 can compute one or more statistical parameters of the candidate feature variables based on the training data 220, e.g., a variance inflation factor (VIF), a Pearson correlation coefficient, a Spearman's rank correlation coefficient, or a Kendall rank correlation coefficient. The system 200 can compare the one or more statistical parameters with one or more threshold values, and determine whether the list of candidate feature variables are independent variables based on the comparison result. This process ensures that the input to the machine-learning model 270 includes only independent variables and improves the performance of the machine-learning model because multi-collinearity seriously affects the performance of a regression model.

In an illustrative example, the training input of the training data can include parameters characterizing an example client, such as data characterizing the sales order amount, consumption based billing, service cost trend, service request trend, customer satisfaction score (CSAT), future insight score, revenue trend, purchase frequency trend, and so on, of the client. However, these parameters may not be the most effective predictive variables for the machine-learning model. Instead, the system can identify the predictive variables (i.e., the feature variables) based on the context data, such as a revenue re-cast impact score, a service impact score, marketing insight score, a customer behavior score, and so on. These values of the feature variables can be derived from the values of the training inputs of the training data. For example, the revenue re-cast impact score can be derived from the data characterizing the sales order amount and the consumption based billing. The service impact score can be derived from the data characterizing the service cost trend and the service request trend. The marketing insight score can be derived from data characterizing the CSAT and the future insight score. The customer behavior score can be derived from data characterizing the revenue trend and the purchase frequency trend. Thus, the system 200 can generate feature variable training data by processing the training data based on the identified feature variables. In some implementations, when the sample size is small, the system can use a Bayesian technique, e.g., a Monte Carlo Markov Chain (MCMC) or a No-U turn sampling to process the training data based on the identified feature variables to generate the feature variable training data.

The system 200 can construct the machine-learning model 270 based on the identified feature variables. For example, the system 200 can select the size and/or architecture of the machine-learning model based on the number of identified feature variables and/or their properties.

The system 200 includes a training engine 260 configured to perform training of the machine-learning model to generate model parameter data for the machine-learning model based at least on the generated feature variable training data. The model parameter data characterizes the model parameters 275 of the machine-learning model 270. The training engine 260 can use any appropriate training techniques for training the machine-learning model 270, such as using gradient descent for a linear regression model, or using backpropagation-based techniques, e.g., the Adam or AdaGrad optimizers for a neural network model.

In some implementations, the system 200 further includes a selection engine 250 to determine whether to train the machine-learning model using a frequentist approach or a Bayesian approach. In the frequentist training approach, the training engine 260 can directly update the values of the model parameters 275 in the training process. In the Bayesian training approach, the training engine 260 determines parameters characterizing the statistical distributions of the model parameters 275 instead. The frequentist training approach is in general more computational efficient but requires sufficient training data to generate high-quality training results. On the other hand, the Bayesian training approach can leverage the domain knowledge data 230 to generate additional training data with assignment of prior probability of data distribution on feature variable(s), and thus can outperform the frequentist training approach. In general, the domain knowledge data 230 characterizes the prior probabilities of the feature variables. For example, the domain knowledge data 230 can define the distribution type (e.g., a Student's t-distribution, a normal distribution, an inverse gamma distribution, or a uniform distribution) and distribution parameters (the mean and standard deviation values) of the prior probabilities of each feature variable. The domain knowledge data 230 and be data estimated by experts or expert systems specialized in the field of an application.

A frequentist statistics-based machine-learning training approach, e.g., a conventional ordinary least square regression can provide a single point estimate for the output, which can be interpreted as the most probable estimate given the training data. By contrast, in Bayesian linear regression, e.g., when the training dataset is small, the estimate of the data can be interpreted as a distribution of possible values. Compared to the frequentist approach, the Bayesian approach has certain advantages. In general, the Bayesian approach is more reliable for dealing with uncertainty. It can quantify the uncertainty involved with small size of data and can effectively combine that uncertainty with data likelihood and prior. In particular, Bayesian regression modeling is advantageous in scenarios with insufficient data and poor distribution related issues by assigning approximate prior on the coefficients.

From a Bayesian perspective, linear regression model is formulated applying probability distributions. The target variable is presumed to be drawn from a probability distribution, instead of a single point estimate. In Bayesian paradigm, the value of the target variable can be expressed as:

y˜N(β^{T}X,σ²I)

Here the target (y) is characterized by a Normal/Gaussian distribution. The mean value of the target is the product of the transpose of the parameter weight matrix (β^{T}) and the predictor matrix (X); whilst the product of variance (σ²) and the identity matrix (I) represents the variance of the target variable.

The posterior probability distribution of the model parameters can be expressed as:

$$P ( β \vert y , X ) = \frac{P ( y \vert β , X ) * P ( β \vert X )}{P ( y \vert X )}$$

The posterior (P(β|y, X)) is the ratio of the product of likelihood of the data (P(Y|β, X)) and prior probability (P(β|X)) of the parameters to a normalized parameter (P(y|X)).

The Bayesian modeling can include three steps. 1. The system constructs the model with some intelligent assumptions about the data generating process. Most of the time, assumptions are intelligent approximations with the help of domain knowledge. 2. Then the system applies the Bayes' theorem and adds the available data to the models and derive the posterior—the logical significant outcome of combining the data with the assumptions. It can be said that the model is now subject to the input data. 3. Finally, the system determines whether the model can be authenticated according to different criteria, based on the data and expertise/domain knowledge on the problem.

In some cases, determining the posterior distribution for the model parameters can be intractable. Thus, in some implementations, the system can use sampling methods, e.g., Monte Carlo sampling, to draw/generate samples from the prior to derive the approximate value of the posterior. In one particular example, a Markov Chain Monte Carlo (MCMC) method can be used for the sampling.

More generally, the Monte Carlo method is a technique of using repeated random samples. Using Monte Carlo we carry out many repeated experiments, each time slightly changing the variables in a model and observing the outcome. By choosing many random values, the system can explore a large portion of the model parameter space, the range of possible values for the variables/parameters. Particularly, the MCMC is a technique for estimating the statistic of a complex model by simulation With Monte Carlo sampling, successive random selections construct a Markov chain. After a series of sampling steps, the Markov chain becomes stationary which is the target distribution according to our expectation. It is particularly useful for determining the posterior distributions of model parameter values in complex Bayesian models.

In an MCMC process, the system generates samples from a probability distribution in order to approximately construct the most likely distribution. Instead of directly calculating the distribution, the system generates a plurality of values, e.g., thousands of values—called samples—for the parameters of the function to resemble the true distribution. The proposition behind MCMC sampling process is that as the system generates more samples, the approximation becomes closer to the true distribution.

In some implementations, for the Bayesian modeling, the system utilizes conjugate priors. The conjugate priors can be used (sometimes an essential condition) to provide a closed-form expression/solution for the posterior distribution. Further, by using the conjugate priors, the system can determine how the parameters of the prior is restructured after the Bayesian update. The system can choose the prior probability distribution of a feature variable based on the domain knowledge data, so that the posterior probability reflects the true behavior of the feature variable while satisfying the criteria of conjugacy to build the successful machine learning model.

In one example, the system can use Half-Cauchy distribution as prior data distribution. A half-Cauchy is one of the symmetric halves of the Cauchy distribution (generally the right half). In another example, the system can use the inverse gamma as the prior distribution. In another example, the system can use half-t priors instead of the inverse gamma because the half-t priors have better behavior to satisfy the conjugacy criteria.

In order to determine whether to train the machine-learning model using a frequentist approach or a Bayesian approach, the selection engine 250 can determine one or more parameters indicating a predictive value of the feature variable training data, and determines, based on the one or more parameters, whether the training data satisfies a sufficiency condition. For example, the one or more parameters can include a coefficient of determination or a mean-squire error computed by fitting the feature variable training data to a predictive model. The selection engine 250 can compare the coefficient of determination or the mean-squire error to a threshold value, and determine whether the training data satisfy the sufficiency condition based on the comparison result. For example, if the coefficient of determination is below 80%, it may indicate that the training data is insufficient and/or the model is not reliable.

In some implementations, the system 200 further includes an evaluation engine 280 to evaluate the performance of the machine-learning model 270. If the evaluation engine 280 determines that a performance metric of the machine-learning model 270 with the trained model parameters 275 is below a threshold, the system 200 can perform further training of the machine-learning model on an updated set of training examples. Thus, the evaluation engine 280 provides a feedback mechanism for updating the training of the machine-learning model. This can be useful when the characteristics and statistics of new data evolve over time. In this case, the system 200 can keep track of and maintain the performance of the model even when the input data changes characteristics.

In particular, the evaluation engine 280 can perform a statistical hypothesis test on the feature variable training data and feature variable test data generated from additional test data 290, and determine, based at least on the result of the statistical hypothesis test, whether to perform an updated training of the machine-learning model. For example, the statistical hypothesis test can include one or more of: a T-test, a Z-test, a chi-square test, an ANOVA test, a binomial test, or a one sample median test. In some implementations, the evaluation engine 280 can further determine a value of an error metric of the machine-learning model based on the test data 290 and the current values of the model parameters 275, and determine, based on the result of the statistical hypothesis test and the error metric, whether to perform an updated training of the machine-learning model.

In some implementations, after obtaining the training data 220, the system 200 further performs a clustering analysis of the training data, and segments the training data into a plurality of training subsets. The system 200 can perform training of the machine-learning model using each of the training subsets to determine the respective parameter values of the model parameters 275 for the respective training subset. In particular, the clustering analysis can be performed using affinity propagation, where the number of clusters does not need to be pre-determined. The clustering process can be beneficial when there are significant variations among the training examples.

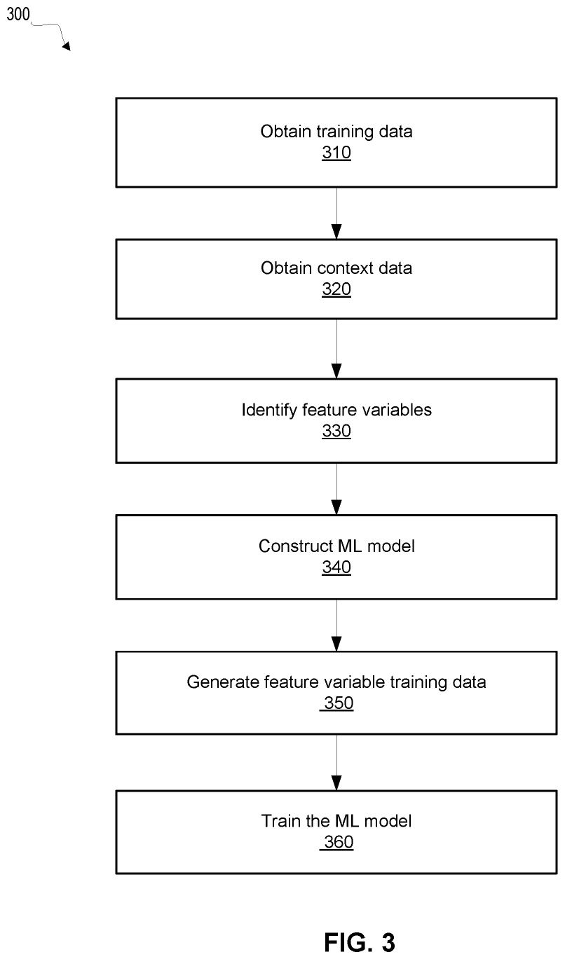

FIG. 3 is a flow diagram illustrating an example process 300 for constructing and training a machine-learning model for making a recommendation. For convenience, the process 300 will be described as being performed by a system of one or more computers located in one or more locations. For example, the system 200 described with reference to FIG. 2, appropriately programmed in accordance with this specification, can perform the process 300.

In step 310, the system obtains training data including a plurality of training examples. In step 320, the system obtains context data characterizing a scenario. In step 330, the system identifies one or more feature variables from the context data. In step 340, the system constructs the machine-learning model based at least on the identified feature variables. In step 350, the system generates feature variable training data by processing the training data based on the identified feature variables. In step 360, the system performs training of the machine-learning model to generate model parameter data for the machine-learning model based at least on the generated feature variable training data.

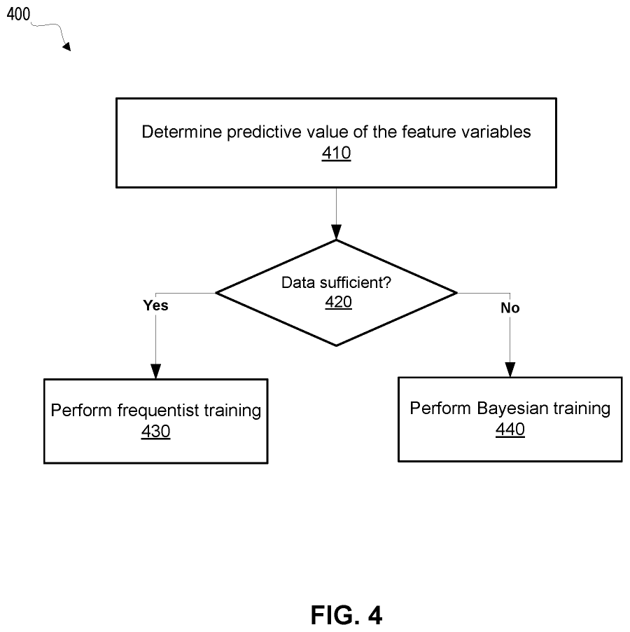

FIG. 4 is a flow diagram illustrating an example process 400 for training a machine-learning model for making a recommendation. For convenience, the process 400 will be described as being performed by a system of one or more computers located in one or more locations. For example, the system 200 described with reference to FIG. 2, appropriately programmed in accordance with this specification, can perform the process 300.

In step 410, the system determines one or more parameters indicating a predictive value of the feature variable training data derived from training data. In step 420, the system determines, based on the one or more parameters, whether the training data satisfies a sufficiency condition. For example, the one or more parameters can include a coefficient of determination or a mean-squire error computed by fitting the feature variable training data to a predictive model, or the Cohen's effect size computed for the statistical power of a multiple regression model fitted to the feature variable training data. The system can determine whether the training data satisfy the sufficiency condition by comparing the Cohen's effect size, the coefficient of determination, or the mean-squire error to a threshold value.

In step 430, in response to the training data satisfying the sufficiency condition, the system performs training of the machine-learning model using a frequentist training technique based on the feature variable training data. In step 440, in response to the training data not satisfying the sufficiency condition, the system performs training of the machine-learning model using a Bayesian training technique based at least on the prior probabilities of the feature variables.

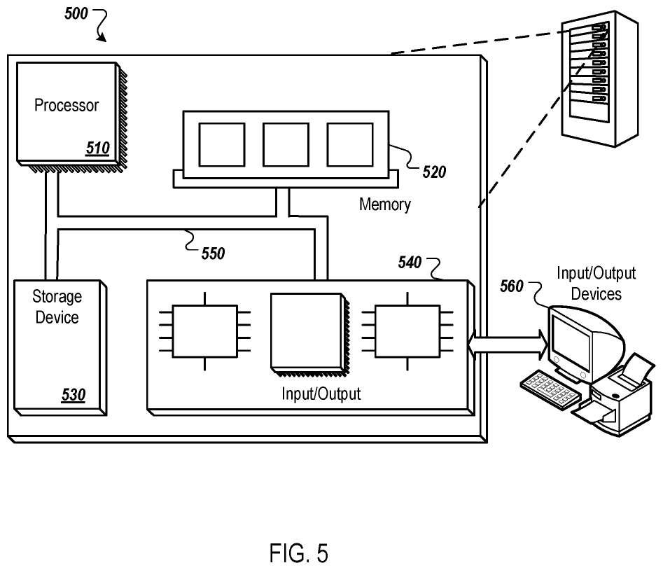

FIG. 5 shows an example computer system 500 that can be used to perform certain operations described above, for example, to perform the operations of the system 100 of FIG. 1, the system 200 in FIG. 2, or the system 300 in FIG. 3. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (for example, a cloud storage device), or some other large-capacity storage device.

The input/output device 540 provides input/output operations for the system 500. In one implementation, the input/output device 540 can include one or more network interface devices, for example, an Ethernet card, a serial communication device, for example, a RS-232 port, and/or a wireless interface device, for example, a 502.11 card. In another implementation, the input/output device can include driver devices configured to receive input data and send output data to other input/output devices, for example, keyboard, printer and display devices 560. Other implementations, however, can also be used, such as mobile computing devices, mobile communication devices, set-top box television client devices, etc.

Although an example system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by a data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, that is, one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, for example, a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, for example, an FPGA (field programmable gate array) or an ASIC (application-specific integrated circuit). The apparatus can optionally include, in addition to hardware, code that creates an execution environment for computer programs, for example, code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, for example, an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device, for example, a universal serial bus (USB) flash drive, to name just a few.

Computer-readable media suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks.

To provide for interaction with a user, embodiments of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of messages to a personal device, for example, a smartphone that is running a messaging application and receiving responsive messages from the user in return.

Data processing apparatus for implementing machine learning models can also include, for example, special-purpose hardware accelerator units for processing common and compute-intensive parts of machine learning training or production, that is, inference, workloads.

Machine learning models can be implemented and deployed using a machine learning framework, for example, a TensorFlow framework, a Microsoft Cognitive Toolkit framework, an Apache Singa framework, or an Apache MXNet framework.

Embodiments of the subject matter described in this specification can be implemented in a computing system that includes a back-end component, for example, as a data server, or that includes a middleware component, for example, an application server, or that includes a front-end component, for example, a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, for example, a communication network. Examples of communication networks include a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, for example, an HTML page, to a user device, for example, for purposes of displaying data to and receiving user input from a user interacting with the device, which acts as a client. Data generated at the user device, for example, a result of the user interaction, can be received at the server from the device.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for training a machine-learning model configured to generate a prediction and recommendation output from input data, the method comprising:
obtaining training data including a plurality of training examples;
obtaining context data characterizing a context of a scenario;
identifying one or more feature variables having sufficient predictive power from the context data;
constructing the machine-learning model based at least on the identified feature variables;
generating feature variable training data by processing the training data based on the identified feature variables; and
performing training of the machine-learning model to generate model parameter data for the machine-learning model based at least on the generated feature variable training data.

2. The method of claim 1, wherein:
the context data includes text data;
and identifying one or more feature variables having sufficient predictive power from the context data comprises:
performing topic modeling of the text data to extract a list of topics;
identifying a list of candidate feature variables based on the list of topics; and
identifying the one or more feature variables based on the list of candidate feature variables.

3. The method of claim 2, wherein identifying one or more feature variables having sufficient predictive power from the context data further comprises:
determining whether the list of candidate feature variables are independent variables, and removing one or more of the candidate feature variables from the list in response to determining that inter-dependencies exist in the list of candidate feature variables to remove multi-collinearity from the list of candidate feature variables.

4. The method of claim 3, wherein determining whether the list of candidate feature variables are independent variables comprises:
determining one or more statistical parameters of the candidate feature variables, the one or more statistical parameters including one or more of: a variance inflation factor (VIF), a Pearson correlation coefficient, a Spearman's rank correlation coefficient, or a Kendall rank correlation coefficient;
comparing the one or more determined statistical parameters with one or more threshold values; and
determining whether the list of candidate feature variables are independent variables based on the comparison result.

5. The method of claim 1, wherein the input data includes one or more parameters characterizing a client system, and the prediction and recommendation output indicates whether to recommend a particular approach for performing a service to the client system.

6. The method of claim 1, wherein the input data includes one or more parameters characterizing a task, and the prediction and recommendation output indicates whether to recommend a particular approach for allocating resources for performing the task.

7. The method of claim 1, wherein performing training of the machine-learning model comprises:
determining one or more parameters indicating a predictive value of the feature variable training data; and
determining, based on the one or more parameters, whether the training data satisfies a sufficiency condition.

8. The method of claim 7, wherein:
the one or more parameters include a Cohen's effect size, a coefficient of determination, or a mean-squire error computed by fitting the feature variable training data to a predictive model; and
determining whether the training data satisfy the sufficiency condition comprises:
comparing the Cohen's effect size, the coefficient of determination, or the mean-squire error to a threshold value; and
determining whether the training data satisfy the sufficiency condition based on the comparison result.

9. The method of claim 7, wherein performing training of the machine-learning model further comprises:
in response to the training data satisfying the sufficiency condition, performing training of the machine-learning model using a frequentist training technique based on the feature variable training data.

10. The method of claim 7, wherein performing training of the machine-learning model further comprises:
obtaining domain knowledge data that characterizes prior probabilities of the feature variables; and
in response to the training data not satisfying the sufficiency condition, performing training of the machine-learning model using a Bayesian training technique based at least on the prior probabilities of the feature variables.

11. The method of claim 1, further comprising:
obtaining test data;
performing a statistical hypothesis test on the feature variable training data and feature variable test data generated for the test data;
determining, based at least on result of the statistical hypothesis test, whether to perform an updated training of the machine-learning model; and
in response to determining to perform the updated training, performing training of the machine-learning model on an updated set of training examples.

12. The method of claim 11, wherein the statistical hypothesis test includes one or more of: a T-test, a Z-test, a chi-square test, an ANOVA test, a binomial test, or a one sample median test.

13. The method of claim 11, wherein determining whether to perform an updated training of the machine-learning model further comprises:
determining a value of an error metric of the machine-learning model based on the test data; and
determining, based on the result of the statistical hypothesis test and the error metric, whether to perform an updated training of the machine-learning model.

14. The method of claim 1, further comprising:
performing a clustering analysis of the training data;
segmenting the training data into a plurality of training subsets; and
performing training of the machine-learning model using each of the training subsets.

15. The method of claim 14, wherein the clustering analysis is performed using affinity propagation.

16. The method of claim 1, wherein generating the feature variable training data comprises:
processing the training data based on the identified feature variables using Monte Carlo Markov Chain (MCMC) or No-U turn sampling to generate the feature variable training data.

17. A computer-implemented method for providing service recommendations, comprising:
obtaining input data that includes at least one or more first parameters characterizing a service-providing system;
processing the input data using a machine learning model to generate a prediction and recommendation output that indicates whether to recommend a particular approach for performing a service by the service-providing system, wherein the machine-learning model has been trained by a training method of claim 1; and
performing an action based on the prediction and recommendation output.

18. A system comprising one or more computers and one or more storage devices storing instructions that when executed by the one or more computers cause the one or more computers to perform operations comprising:
obtaining training data including a plurality of training examples;
obtaining context data characterizing a context of a scenario;
identifying one or more feature variables having sufficient predictive power from the context data;
constructing the machine-learning model based at least on the identified feature variables;
generating feature variable training data by processing the training data based on the identified feature variables; and
performing training of the machine-learning model to generate model parameter data for the machine-learning model based at least on the generated feature variable training data.

19. The system of claim 18, wherein:
the context data includes text data;
and identifying one or more feature variables having sufficient predictive power from the context data comprises:
performing topic modeling of the text data to extract a list of topics;
identifying a list of candidate feature variables based on the list of topics; and
identifying the one or more feature variables based on the list of candidate feature variables.

20. One or more non-transitory computer storage media encoded with instructions that, when executed by one or more computers, cause the one or more computers to perform the operations comprising:
obtaining training data including a plurality of training examples;
obtaining context data characterizing a context of a scenario;
identifying one or more feature variables having sufficient predictive power from the context data;
constructing the machine-learning model based at least on the identified feature variables;
generating feature variable training data by processing the training data based on the identified feature variables; and
performing training of the machine-learning model to generate model parameter data for the machine-learning model based at least on the generated feature variable training data.
